(19) United States
(12) Patent Application Publication
(10) Pub. No.: US 2007/0257887 A1
(43) Pub. Date: Nov. 8, 2007

(54) APPARATUS AND METHOD FOR CURSOR CONTROL

(75) Inventor: Yi-Chieh Chang, Taichung City (TW)

Correspondence Address: J C PATENTS, INC., 4 VENTURE, SUITE 250, IRVINE, CA, 92618, US

(73) Assignee: SUNPLUS TECHNOLOGY CO., LTD., Hsinchu (TW)

(21) Appl. No.: 11/742,285

(22) Filed: Apr. 30, 2007

(30) Foreign Application Priority Data
May 4, 2006 (TW) 95115851

(51) Int. Cl. G09G 5/08

(52) U.S. Cl. 345/166

(57) ABSTRACT

An apparatus and a method for cursor control are provided. The present invention combines an optical mouse with a stationary pad, and integrates the shift information detected by a light sensor and pressure sensors. Therefore, accurate shift detection can be realized within limited space so as to control the cursor on the screen. In addition, the power of the optical mouse can be supplied by the stationary pad, such that the burden for movement of the optical mouse can be reduced.

### CROSS-REFERENCE TO RELATED APPLICATION

This application claims the priority benefit of Taiwan application serial no. 95115851, filed May 4, 2006. All disclosure of the Taiwan application is incorporated herein by reference.

### BACKGROUND OF THE INVENTION

1. Field of Invention

The present invention relates to an apparatus for cursor control. More particularly, the present invention relates to an optical mouse applicable to operating on various surfaces.

2. Description of Related Art

With the popularity of personal computers, various peripheral products are developed to meet the requirements of consumers, among which the most widely used is the mouse to control the cursor on the computer screen. According to the method of detecting the move, conventional mice can be classified into two categories, namely, non-optical mechanism and optical mechanism. A common non-optical mechanism utilizes the rolling of a ball roller at the bottom of the mouse to detect the move, as disclosed in U.S. Pat. No. 5,670,990. An optical mechanism utilizes an image sensor to acquire an image reflected by the desktop to detect the move, as disclosed in U.S. Pat. No. 6,433,780.

U.S. Pat. No. 5,670,990 discloses a positioning device integrated with a ball roller. The non-optical mouse makes use of the move caused by the friction between the ball roller at the bottom of the mouse and the desktop or the pad to drive the roll shaft in contact with the ball roller in the mouse to roll. The roll amount of the roll shaft is converted into an electronic signal to control the moving direction and the moving amount of the cursor on the screen. However, the mouse using the non-optical mechanism has a defect that the sensitivity of the mouse will gradually degrade due to the dust accumulated on the ball roller and the internal roll shaft. When the sensitivity degrades, the ball roller at the bottom of the mouse has to be disassembled for cleaning, such that the sensitivity of the mouse is restored.

U.S. Pat. No. 6,433,780 discloses a visible mouse for a computer system. The mouse that uses the optical mechanism to detect the moving amount irradiates lights onto the desktop with a light source (e.g., LED) disposed in the bottom portion of the mouse, and utilizes a two-dimensional image sensor to acquire special patterns formed corresponding to the micro texture of the desktop after being irradiated by the light source. A corresponding image processing mechanism converts the change of the acquired image patterns caused by the movement of the mouse into the shift amount which is properly represented by the amount and direction of movement of the cursor on the screen. However, as the mouse using the optical mechanism detects the shift amount of mouse based on the change of the acquired images, in case that the mouse is used on a smooth desktop without any texture changes, the images acquired by the image sensor will not change with the move of the mouse, and the mouse cannot function normally on this type of desktops, thus limiting the applications. Moreover, when there is no enough room for a user to use and move the optical mouse, the usage of the mouse is inconvenient and limited. Therefore, conventional optical mice still have many disadvantages and need to be improved.

### SUMMARY OF THE INVENTION

Accordingly, one objective of the present invention is to provide an apparatus for cursor control that integrates an optical mouse and a stationary pad as a whole, which is applicable to various surfaces.

Another objective of the present invention is to provide an apparatus for cursor control, in which when an optical mouse moves over a certain distance, the moving direction and moving amount of the cursor are determined by the pressure sensors instead, such that the cursor control can be accomplished in a limited space.

Still another objective of the present invention is to provide a method for cursor control, wherein a light sensor and pressure sensors are used to detect the moving direction and moving amount of an optical mouse so as to control the cursor.

In order to achieve the aforementioned and other objectives, the present invention provides an apparatus for cursor control, which comprises an optical mouse, a stationary pad, a shield, and a plurality of pressure sensors. The optical mouse is used to detect a shift direction and a shift amount, so as to control the cursor on the screen, while the stationary pad is used to allow the optical mouse to move on a fixed plane. Moreover, the shield is used to confine the optical mouse to movement on the fixed plane of the stationary pad, while the pressure sensors are disposed around the optical mouse for detecting the contact between the optical mouse and the shield and controlling the cursor on the screen according to the positions of the pressure sensors in contact with the shield.

According to the apparatus for cursor control described in one embodiment of the present invention, the pressure sensors include multi-level pressure sensors for determining the moving speed of the cursor on the screen according to a pressure level detected by the pressure sensors.

According to the apparatus for cursor control described in one embodiment of the present invention, the optical mouse comprises a light sensor for controlling the cursor on the screen according to the change of an acquired picture, and the surface of the stationary pad is drawn with a lattice pattern for enabling the optical mouse to identify the change of the picture.

According to the apparatus for cursor control described in one embodiment of the present invention, a distance is kept between the optical mouse and the stationary pad for enabling the optical mouse to enter a suspended state when the optical mouse is lifted up so as to lock the cursor on the screen.

According to the apparatus for cursor control described in one embodiment of the present invention, the optical mouse is connected to the stationary pad via a power line, and gets required power from the stationary pad. In addition, the optical mouse can also be connected to the stationary pad via a data line, and exchange the detected shift direction and shift amount with the stationary pad.

According to the apparatus for cursor control described in one embodiment of the present invention, the optical mouse or the stationary pad is connected to an external computer through a wireless transmission device to transmit the detected shift direction and amount and control the cursor on the screen according to the detection.

The present invention provides an apparatus for cursor control, which comprises an optical mouse, a stationary pad, a shield, and a plurality of pressure sensors. The optical mouse is used to detect a shift direction and a shift amount, so as to control the cursor on the screen, while the stationary pad is used to allow the optical mouse to move on a fixed plane. Moreover, the shield is used to confine the optical mouse on the stationary pad, while the pressure sensors are disposed around the shield and are used to detect the contact between the shield and the optical mouse, so as to control the cursor on the screen according to the positions of the pressure sensors in contact with the optical mouse.

The present invention provides a method for cursor control suitable for controlling the cursor on the screen. The method comprises first detecting a shift direction and a shift amount of the optical mouse on the stationary pad, so as to control the cursor on the screen, and determining the moving direction of the cursor on the screen according to the positions of the plurality of pressure sensors in contact with the optical mouse when the optical mouse moves to the edge of the stationary pad.

The method for cursor control according to one embodiment of the present invention further comprises detecting the pressure level that the optical mouse contacts the pressure sensors and determining the moving speed of the cursor on the screen according to the pressure level.

According to the method for cursor control described in one embodiment of the present invention, the step of determining the shift direction and shift amount of the optical mouse on the stationary pad comprises acquiring a reference picture on the surface of the stationary pad with a light sensor, then acquiring a sample picture after a predetermined time period, and producing the shift direction and shift amount by comparing the reference picture with the sample picture.

The method for cursor control according to one embodiment of the present invention further comprises when the difference between the reference picture and the sample picture exceeds a predetermined value, entering a suspended state, and locking the cursor on the screen.

The present invention provides an apparatus for cursor control, suitable for being disposed in a portable electronic device having a screen. The apparatus for cursor control comprises an optical mouse, a stationary pad, a shield, and a plurality of pressure sensors. The optical mouse is used to detect a shift direction and a shift amount, so as to control the cursor on the screen, while the stationary pad is used to allow the optical mouse to move on a fixed plane. Moreover, the shield is used to confine the optical mouse to move on the fixed plane of the stationary pad, while the pressure sensors are disposed around the optical mouse and are used to detect the contact between the optical mouse and the shield so as to control the cursor on the screen according to the positions of the pressure sensors in contact with the shield.

The present invention adopts a structure of combining the optical mouse and the stationary pad, such that the optical mouse is limited to move in a fixed range, and when the optical mouse moves to the edge of the stationary pad, the move of the optical mouse is detected by the pressure sensors instead, so as to control the cursor on the screen.

In order to make the aforementioned and other objectives, features and advantages of the present invention comprehensible, preferred embodiments accompanied with figures are described in detail below.

### BRIEF DESCRIPTION OF THE DRAWINGS

FIG. 1 is the top view of the apparatus for cursor control according to the first embodiment of the present invention.

FIG. 2 is the sectional view of the apparatus for cursor control according to the first embodiment of the present invention.

FIG. 3 is the sectional view of the apparatus for cursor control according to the second embodiment of the present invention.

FIG. 4(a) is the sectional view of the foldable optical mouse according to the second embodiment of the present invention.

FIG. 4(b) is the sectional view of the foldable optical mouse according to the second embodiment of the present invention.

FIG. 5 is the foldable optical mouse applied in a laptop according to the second embodiment of the present invention.

FIG. 6 is the flow chart of the method for cursor control according to the third embodiment of the present invention.

### DESCRIPTION OF EMBODIMENTS

In order to make the present invention apparent, some embodiments are described below, and the present invention can be implemented accordingly.

The present invention adopts a structure of combining the optical mouse and the stationary pad, and utilizes the light sensor and the pressure sensors together to detect the move of the optical mouse, wherein the pressure sensors are disposed around the optical mouse, or around the shield that connects the optical mouse and the stationary pad. Each of the two arrangements of the pressure sensors is illustrated in detail below with an embodiment.

### The First Embodiment

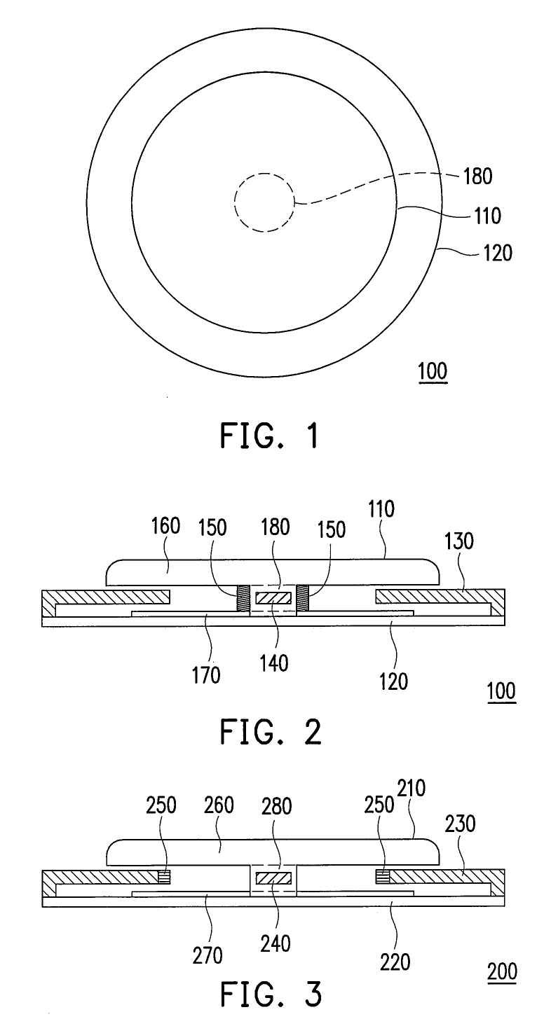

FIGS. 1 and 2 are the top view and the sectional view of the apparatus for cursor control according to the first embodiment of the present invention respectively. Referring to FIGS. 1 and 2 together, the same numerals in the figures indicate the same objects. The apparatus for cursor control 100 of the present embodiment is used to control the cursor on the screen, and mainly comprises an optical mouse 110, a stationary pad 120, and a shield 130. A light sensor 140 and a plurality of pressure sensors 150 are disposed on the optical mouse 110. The detailed functions of each of the objects are described in the following.

As shown in FIG. 2, the optical mouse 110 of the present embodiment comprises an upper disc 160 and a lower disc 170, which are connected with a pillar 180 therebetween. Moreover, a light sensor 140 is disposed in the pillar 180, and a plurality of pressure sensors 150 are disposed around the pillar 180. Similar to light sensors in the common optical mouse, the light sensor 140 determines the shift direction and shift amount of the optical mouse according to the pictures reflected from the stationery pad through the opening at the bottom of the pillar 180. The shift direction and shift amount is then provided to the computer as a reference for the computer to control the cursor on the screen. Moreover, a lattice pattern is drawn on the surface of the stationary pad 120, such that the optical mouse 110 can compare the difference between pictures more precisely after capturing the picture, thereby improving the recognition rate of the captured pictures.

The optical mouse 110 is confined on the stationary pad 120 with the shield 130, and a fixed plane is formed on the stationary pad 120 to allow the optical mouse to move on the stationary pad 120. In addition, the lower disc 170 of the optical mouse 110 is disposed in the fixed plane formed by the shield 130 and the stationary pad 120, and the gap of the shield 130 is smaller than the lower disc 170 of the optical mouse 110, thus avoiding the separation of the optical mouse 110 from the stationary pad 120.

As the shield 130 limits the move range of the optical mouse 110, when the optical mouse 110 moves to the edge of the fixed plane, another mechanism is used to replace with the detection for the information of the move so as to control the cursor. At this time, the pressure sensors 150 around the pillar 180 of the optical mouse are used instead to detect the moving direction and moving amount. In particular, when the optical mouse 110 moves to the edge of the fixed plane, the pressure sensors 150 around the pillar 180 of the optical mouse touch the shield 130. At this time, the apparatus for cursor control 100 reflects the moving direction of the cursor on the screen according to the positions of the pressure sensors 150 in contact with the shield 130, so as to control the cursor to move in the aforementioned direction continuously until the contact between the pressure sensors 150 and the shield 130 is released.

Moreover, the pressure sensors 150 are, for example, multi-level pressure sensors, which can determines the moving speed of the cursor on the screen according to the detected level of pressure. However, it is apparent to those skilled in the art that the pressure sensors of the present invention can be disposed on the optical mouse 110 as required, and the number and the arrangement manner of the pressure sensors are not limited to this. The moving speed of the cursor can be a predetermined moving speed, and the moving direction can be obtained by calculating the positions of the plurality of pressure sensors in contact with the optical mouse 110 by the method of interpolation, which will not be limited herein.

As shown in FIG. 2, a distance exists between the optical mouse 110 and the stationary pad 120, and the distance is the distance between the lower disc 170 and the stationary pad 120 when the optical mouse 110 is lifted up. When the optical mouse 110 needs to move in use, or when the optical mouse 110 needs to be lifted up as the user wants to move the entire apparatus for cursor control 100, the distance formed between the bottom of the optical mouse 110 and the stationary pad 120 makes the pictures acquired by the light sensor 140 greatly change. In order to avoid the wrong move of the cursor caused by the abrupt change of pictures, the apparatus for cursor control 100 can use an image processing mechanism to detect the situation that “the optical mouse is lifted up”, so as to enter a suspended state and lock the cursor on the screen.

It should be noted that the power of conventional wireless optical mice is supplied by batteries disposed therein, thus resulting an increase in the weight of the optical mouse. However, in the apparatus for cursor control 100 of the present invention, the optical mouse 110 can be connected to the stationary pad 120 via a power line, and get required power from the stationary pad 120. The power source of the stationary pad 120 can be obtained from the installed battery or an external power source, which will not be limited herein. By adopting the method described above, the burden for the user to move the optical mouse 110 is greatly reduced, and the convenience of the present invention in use is improved. In addition, the optical mouse 110 can be connected to the stationary pad 120 via a data line, so as to exchange the detected shift direction and shift amount with the stationary pad, and can be connected to an external computer through wireless transmission devices such as Bluetooth or infrared wireless transmission device, so as to transmit data of the shift direction and shift amount and so on, thus controlling the cursor on the screen.

To sum up, in the apparatus for cursor control according to the present embodiment, the pressure sensors are disposed around the optical mouse. Therefore, when the optical mouse moves to the edge of the fixed plane, the required information of the move is detected by the pressure sensors instead, so as to correctly control the cursor on the screen.

### The Second Embodiment

FIG. 3 is the sectional view of the apparatus for cursor control according to the second embodiment of the present invention. Referring to FIG. 3, the apparatus for cursor control 200 of the present embodiment is used to control the cursor on the screen, and mainly comprises an optical mouse 210, a stationary pad 220, and a shield 230. A light sensor 240 and a plurality of pressure sensors 250 are disposed on the optical mouse 210. Different from the first embodiment, the pressure sensors 250 of the present embodiment are disposed around the shield 230. The arrangement and function of other objects are similar to those of the first embodiment, and the details will not be described herein again.

In this embodiment, when the optical mouse 210 moves to the edge of the fixed plane, the pillar 280 of the optical mouse 210 touches the pressure sensors 250 around the shield 230. At this time, the apparatus for cursor control 200 reflects the moving direction of the cursor on the screen according to the positions of the pressure sensors 250 in contact with the optical mouse 210, so as to control the cursor to move in the aforementioned direction continuously until the contact between the pressure sensors 250 and the optical mouse 210 is released.

Similarly, the pressure sensors 250 of this embodiment are, for example, multi-level pressure sensors, which can determine the moving speed of the cursor on the screen according to the detected pressure level. Moreover, the pressure sensors 250 can be disposed annularly around the edge of the shield 230 according to the requirements in use. The number of the pressure sensors 250 is determined according to the actual size of the apparatus for cursor control 200, which will not be limited herein.

To sum up, in the apparatus for cursor control according to this embodiment, the pressure sensors are disposed around the shield. Therefore, when the optical mouse moves to the edge of the fixed plane, the required information of the move is detected by the pressure sensors instead, so as to correctly control the cursor on the screen.

It should be noted that in the embodiment described above, the moving range of the optical mouse is only limited in the fixed plane and the size of the apparatus for cursor control can be significantly reduced. Therefore, the apparatus for cursor control of the present invention can also be built in a laptop to replace the conventional touch pad and provide the laptop with another way to control the cursor.

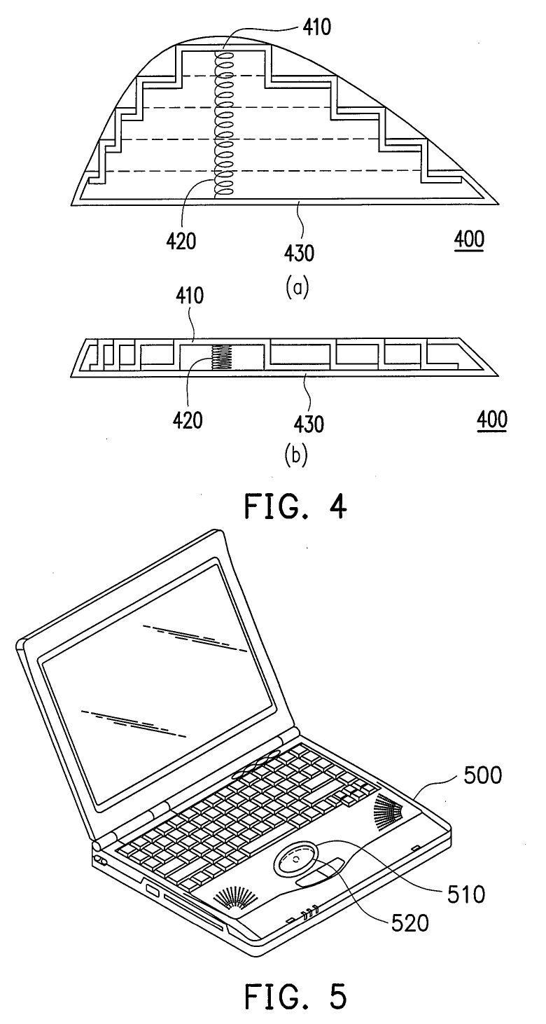

In addition, the optical mouse of the present invention can also adopt a foldable design, as shown in FIG. 4. When a user wants to use the optical mouse, he only needs to softly touch the top of the optical mouse 400, and a housing 410 in the optical mouse 400 is ejected automatically by a spring 420, so as to form an ergonomic shape suitable for palms (as shown in FIG. 4(a)). When the user wants to stop using the optical mouse 400, he can press the top of the optical mouse 400 again to put the housing 410 of the optical mouse 400 back to a base 430 (as shown in FIG. 4(b)). Thus, the actual space that the optical mouse 400 occupies can be saved, and the portability and convenience of the apparatus for cursor control of the present invention can be improved.

Another application of the present invention is to apply the apparatus for cursor control in portable electronic devices such as laptops, PDAs, or translating machines. For example, FIG. 5 is the foldable optical mouse applied in a laptop according to the second embodiment of the present invention. Referring to FIG. 5, if the apparatus for cursor control 510 of the present invention is built in a laptop 500, the apparatus for cursor control 510 can be disposed at the position where the touch pad of the laptop is originally disposed. By adopting the foldable design of the optical mouse 520 described above, when opening or closing the laptop 500, the user can softly touch the top of the optical mouse 520 to control the optical mouse 520 to be ejected from the base or accommodated in the base. Thus, the size of the optical mouse can be reduced, and the convenience for the user to operate can be improved.

### The Third Embodiment

A special method for cursor control can be derived from the apparatuses for cursor control as described in the first and the second embodiments. That is, the cursor is controlled based on information of the move such as the shift direction and shift amount produced by combining the characteristics of the light sensor and the pressure sensors together with the move positions of the optical mouse.

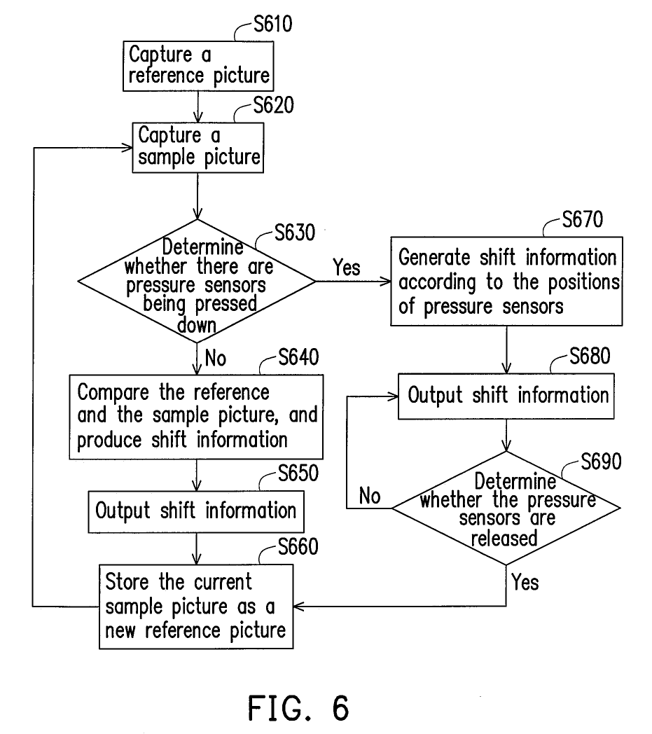

FIG. 6 is the flow chart of the method for cursor control according to the third embodiment of the present invention. Referring to FIG. 6, in the present embodiment, the cursor on the screen is controlled by detecting the shift information of the optical mouse moving on a stationary pad and the shift information produced according to the positions of the pressure sensors in contact with the optical mouse. The steps of the method are described in detail in the following.

First, the light sensor of the optical mouse acquires a picture reflected by the stationary pad as a reference picture (Step S610), and acquires another picture after a predetermined time period as a sample picture (Step S620). At this time, the optical mouse may still move on the stationary pad, or may have moved to the edge of the stationary pad and touched the pressure sensors disposed around the stationary pad. Therefore, the next step is to determine whether there are pressure sensors being pressed down or not due to the touch of the optical mouse (Step S630).

If no pressure sensor is pressed down, this indicates that the optical mouse has not moved to the edge of the stationary pad, and is still moving or pausing on the stationary pad. At this time, the shift data detected by the light sensor is still referred to. Therefore, then the reference picture and the sample picture acquired early are compared, and the shift information of the shift direction and shift amount and so on is produced (Step S640), and the shift information is output (Step S650). Then, the computer receiving the shift information can control the cursor according to the shift information. In addition, in order to continuously detect the move of the optical mouse, the current sample picture must be stored first and serves as a new reference picture (Step S660). Back to Step S620, the next sample picture is acquired. By repeating the picture acquisition and comparison as described above, continuous shift information can be output to control the continuous move of the cursor.

On the other hand, if it is detected that some pressure sensors are pressed down, this indicates that the optical mouse has moved to the edge of the stationary pad and touched the pressure sensors. At this time, the shift information such as the shift direction and shift amount is produced according to the positions of the pressure sensors in contact with the optical mouse (Step S670). The pressure sensors are arranged in advance, and the positions of the pressure sensors are fixed. Therefore, the corresponding shift information can be stored in advance in accordance with the positions. When the pressure sensors touch the optical mouse, the corresponding shift information can be output immediately (Step S680), so as to achieve a rapid response and improve sensitivity.

Definitely, the user may change the moving direction, thus dragging the optical mouse away from the pressure sensors. At this time, the pressure sensors are released. Therefore, it still has to be determined whether the pressure sensors are released or not (Step S690). If the pressure sensors are not released, this indicates that the optical mouse still remains at the position of the pressure sensors, and in this case, back to Step S680 the corresponding shift information is then output. If it is detected that the pressure sensors are released, this indicates that the optical mouse has moved in another direction, and in this case, the light sensor is used again to detect the shift information. At this time, back to Step S660, the latest acquired sample picture (i.e., the last sample picture acquired before touching the pressure sensors) is stored as the new reference picture. Then back to Step 620, a next sample picture is acquired to get the shift information.

In a special situation that the optical mouse is lifted up, as a distance is formed between the light sensor of the optical mouse and the pad, the pictures acquired by the light sensor changes abruptly, which interfere the determination of the shift information. Therefore, when the difference between the reference picture and the sample picture exceeds a predetermined value, the optical mouse enters a suspended state, and stops outputting any shift information, thereby locking the cursor on the screen to avoid unnecessary errors.

It should be noted that the present embodiment only uses single-level pressure sensors to detect the shift information. However, it is apparent to those skilled in the art that the present invention can use multiple-level pressure sensors to determine the moving speed of the cursor on the screen by detecting the pressure levels of the pressure sensors contacting the optical mouse. Furthermore, when the optical mouse touches multiple pressure sensors at the same time, the positions of the pressure sensors in contact with the optical mouse can also be referred to, so as to calculate the shift information more precisely by the method of interpolation.

To sum up, in the apparatus and the method for cursor control of the present invention, a structure of combining an optical mouse and a stationary pad is adopted, and the shift information detected by a light sensor and pressure sensors is integrated, so that accurate shift detection can be realized within limited space so as to control the cursor on the screen. In addition, the power of the optical mouse can also be supplied by the stationary pad, such that the burden for moving the optical mouse can be reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An apparatus for cursor control, suitable for controlling a cursor on a screen, the apparatus for cursor control comprising:
an optical mouse, for detecting a shift direction and a shift amount, so as to control the cursor on the screen;
a stationary pad, for allowing the optical mouse to move on a fixed plane;
a shield, for confining the optical mouse on the stationary pad; and
a plurality of pressure sensors, disposed around the optical mouse, for detecting a contact between the optical mouse and the shield and controlling the cursor on the screen according to the position of the shield in contact with the pressure sensors.

2. The apparatus for cursor control as claimed in claim 1, wherein the pressure sensors are multi-level pressure sensors for determining the moving speed of the cursor on the screen according to a pressure level detected by the pressure sensors.

3. The apparatus for cursor control as claimed in claim 1, wherein the optical mouse comprises a light sensor for controlling the cursor on the screen according to the change of an acquired picture.

4. The apparatus for cursor control as claimed in claim 3, wherein the surface of the stationary pad is drawn with a lattice pattern for comparing the difference between the captured pictures after the optical mouse captures the picture, so as to improve the recognition rate of the captured picture.

5. The apparatus for cursor control as claimed in claim 1, wherein a distance is kept between the optical mouse and the stationary pad for enabling the optical mouse to enter a suspended state when the optical mouse is lifted up, so as to lock the cursor on the screen.

6. The apparatus for cursor control as claimed in claim 1, wherein the optical mouse is connected to the stationary pad via a power line, so as to get required power from the stationary pad.

7. The apparatus for cursor control as claimed in claim 1, wherein the optical mouse is connected to the stationary pad via a data line, so as to exchange the detected shift direction and shift amount with the stationary pad.

8. The apparatus for cursor control as claimed in claim 1, wherein the optical mouse or the stationary pad is connected to an external computer through a wireless transmission device to transmit the shift direction and the shift amount and accordingly control the cursor on the screen.

9. An apparatus for cursor control, suitable for controlling a cursor on a screen, the apparatus for cursor control comprising:
an optical mouse, for detecting a shift direction and a shift amount, so as to control the cursor on the screen;
a stationary pad, for allowing the optical mouse to move on a fixed plane;
a shield, for confirming the optical mouse on the stationary pad; and
a plurality of pressure sensors disposed around the shield, for detecting a contact between the shield and the optical mouse and controlling the cursor on the screen according to the position of the optical mouse in contact with the pressure sensors.

10. The apparatus for cursor control as claimed in claim 9, wherein the plurality of pressure sensors are multi-level pressure sensors for determining the moving speed of the cursor on the screen according to a pressure level detected by the pressure sensors.

11. The apparatus for cursor control as claimed in claim 9, wherein the optical mouse comprises a light sensor for controlling the cursor on the screen according to the change of an acquired picture.

12. The apparatus for cursor control as claimed in claim 11, wherein the surface of the stationary pad is drawn with a lattice pattern for comparing the difference between the captured pictures after the optical mouse captures the picture, so as to improve the recognition rate of the captured picture.

13. The apparatus for cursor control as claimed in claim 9, wherein a distance is kept between the optical mouse and the stationary pad for enabling the optical mouse to enter a suspended state when the optical mouse is lifted up, so as to lock the cursor on the screen.

14. The apparatus for cursor control as claimed in claim 9, wherein the optical mouse is connected to the stationary pad via a power line, so as to get required power from the stationary pad.

15. The apparatus for cursor control as claimed in claim 9, wherein the optical mouse is connected to the stationary pad via a data line, so as to exchange the detected shift direction and shift amount with the stationary pad.

16. The apparatus for cursor control as claimed in claim 9, wherein the optical mouse or the stationary pad is connected to an external computer through a wireless transmission device to transmit the shift direction and the shift amount and accordingly control the cursor on the screen.

17. A method for cursor control, suitable for controlling a cursor on a screen, the method for cursor control comprising:
acquiring a reference picture from the surface of stationary pad by an optical mouse;
acquiring a sample picture after a predetermined time period;
comparing the reference picture and the sample picture to generate a shift direction and a shift amount relating to the movement of optical mouse on the stationary pad, so as to control the cursor on the screen; and
when the optical mouse moves to the edge of the stationary pad, determining the direction of cursor on the screen according to the position of at least one pressure sensor in contact with the optical mouse, and determining the speed of cursor on the screen according to a corresponding pressure level obtained from a contact between the optical mouse and the pressure sensor.

18. The method for cursor control as claimed in claim 17, further comprising:
when the difference between the reference picture and the sample picture exceeds a predetermined value, entering a suspended state, so as to lock the cursor on the screen.

19. An apparatus for cursor control, suitable for being disposed in a portable electronic device having a screen and controlling a curser on the screen, the apparatus comprising:
an optical mouse, for detecting a shift direction and a shift amount, so as to control the cursor on the screen;
a stationary pad, for allowing the optical mouse to move on a fixed plane;
a shield, for confining the optical mouse on the stationary pad;
a plurality of pressure sensors, disposed around the optical mouse, for detecting a contact between the optical mouse and the shield and controlling the cursor on the screen according to the position of the shield in contact with the pressure sensors.

20. The apparatus for cursor control as claimed in claim 19, wherein the pressure sensors are multi-level pressure sensors for determining the moving speed of the cursor on the screen according to a pressure level detected by the pressure sensors.

21. The apparatus for cursor control as claimed in claim 19, wherein the optical mouse comprises a light sensor for controlling the cursor on the screen according to captured pictures.

22. The apparatus for cursor control as claimed in claim 21, wherein the surface of the stationary pad is drawn with a lattice pattern for comparing the difference of captured pictures after the optical mouse captures the picture, so as to improve the recognition rate of the captured pictures.

23. The apparatus for cursor control as claimed in claim 19, wherein a distance is kept between the optical mouse and the stationary pad for enabling the optical mouse to enter a suspended state when the optical mouse is lifted up, so as to lock the cursor on the screen.

24. An apparatus for cursor control, suitable for being disposed in a portable electronic device having a screen and controlling a cursor on the screen, the apparatus comprising:
an optical mouse, for detecting a shift direction and a shift amount, so as to control the cursor on the screen;
a stationary pad, for allowing the optical mouse to move on a fixed plane;
a shield, for confining the optical mouse on the stationary pad;
a plurality of pressure sensors, disposed around the shield, for detecting a contact between the shield and the optical mouse, and controlling the cursor on the screen according to the position of the optical mouse in contact with the pressure sensor.

25. The apparatus for cursor control as claimed in claim 24, wherein the pressure sensors are multi-level pressure sensors for determining the moving speed of the cursor on the screen according to a pressure level detected by the pressure sensors.

26. The apparatus for cursor control as claimed in claim 24, wherein the optical mouse comprises a light sensor for controlling the cursor on the screen according to captured pictures.

27. The apparatus for cursor control as claimed in claim 24, wherein the surface of the stationary pad is drawn with a lattice pattern for comparing the difference of captured pictures after the optical mouse captures the picture, so as to improve the recognition rate of captured pictures.

28. The apparatus for cursor control as claimed in claim 27, wherein a distance is kept between the optical mouse and the stationary pad for enabling the optical mouse to enter a suspended state when the optical mouse is lifted up, so as to lock the cursor on the screen.
